(19) United States
(12) Patent Application Publication
(10) Pub. No.: US 2007/0266140 A1
(43) Pub. Date: Nov. 15, 2007

(54) Network management apparatus

(75) Inventor: Hajime Kawamata, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/801,883

(22) Filed: May 11, 2007

(30) Foreign Application Priority Data
May 15, 2006 (JP) 2006-135012

(51) Int. Cl. G06F 15/173

(52) U.S. Cl. 709/223

(57) ABSTRACT

A network management apparatus, including a communication section connected to a network, a memory for storing a network configuration diagram, a display, an input section, and an arithmetic control section, wherein when at least one device being connected to the network is detected, the arithmetic control section displays an indication on the display whether the device is to be registered in the network configuration diagram, and the arithmetic control section registers the device in the network configuration diagram based on an instruction inputted from the input section.

This application claims foreign priority based on Japanese Patent application No. 2006-135012, filed May 15, 2006, the content of which is incorporated herein by reference in its entirety.

### BACKGROUND OF THE INVENTION

1. Field of the Invention

The present invention relates to a network management apparatus, particularly to a network management apparatus capable of automatically detecting devices on a network and preventing unauthorized devices from being connected to the network by making a user be able to select management target devices from the automatically detected devices.

2. Description of the Related Art

The related arts of the network management apparatus are JP-A-11-316724, JP-A-2002-101125, JP-A-2002-366454 and JP-A-2003-008575, for example.

FIG. 7 is an exemplary block diagram illustrating the network management apparatus of the related art. In FIG. 7, reference numeral 1 denotes a network management apparatus for managing a network, and reference numeral 2 denotes a network such as Internet. The reference numerals 3 and 4 denote devices to be managed (management target devices). The network management apparatus 1 and the devices 3 and 4 are connected to the network 2 respectively.

The exemplary operation of the network management apparatus of the related art shown in FIG. 7 will be described with reference to FIGS. 8 and 9. FIG. 8 is a block diagram illustrating the configuration of the network management apparatus 1, and FIG. 9 is a flowchart illustrating the operation of the network management apparatus 1.

In FIG. 8, reference numeral 5 denotes an arithmetic control section such as a central processing unit (CPU), reference numeral 6 denotes a communication section connected to the devices 3 and 4 via the network 2 to transmit and receive data, reference numeral 7 denotes a memory section such as a read only memory (ROM), a random access memory (RAM), a flash memory (ROM capable of electrically rewriting data) or a hard disk, reference numeral 8 denotes a display section such as a cathode ray tube (CRT), and reference numeral 9 denotes an input section such as a keyboard.

The network management apparatus 1 includes the arithmetic control section 5, the communication section 6, the memory 7, the display section 8 and the input section 9. The arithmetic control section 5 is connected to the communication section 6, the memory 7, the display section 8 and the input section 9 respectively.

The network management apparatus 1 has a function (hereinafter, referred to as an automatic detection function) of automatically detecting devices connected to the network 2, and application software having the automatic detection function is installed in the memory section 7 in advance.

The data including a network configuration diagram is stored in the memory section 7 in advance, so that the network management apparatus 1 can manage the devices connected to the network 2. The network configuration diagram is a diagram showing names of the devices connected to the network (host names), Internet protocol (IP) addresses, levels of importance of the devices, and the like.

In step “S001” shown in FIG. 9, the arithmetic control section 5 of the network management apparatus 1 reads the application software having the automatic detection function from the memory section 7 to execute the application software, controls the communication section 6 and thus determines whether devices are detected on the network 2. When the devices are detected, the arithmetic control section 5 of the network management apparatus 1 registers the detected devices in the network configuration diagram in step “S002” shown in FIG. 9.

Specifically, when the devices 3 and 4 are connected to the network 2 as shown in FIG. 7, the network management apparatus 1 detects the devices 3 and 4 by the automatic detection function, and then registers the devices 3 and 4 in the network configuration diagram. Then, the network management apparatus 1 starts to monitor the state of the registered devices 3 and 4.

As a result, when the network management apparatus 1 detects the devices on the network 2 by the automatic detection function, the detected devices are registered in the network configuration diagram. In this manner, since the devices are automatically registered in the network configuration diagram, it is possible to thoroughly monitor the state of the devices connected to the network 2.

However, in the related art example shown in FIG. 7, when the network management apparatus 1 detects the devices on the network 2, the detected devices are automatically registered in the network configuration diagram. Consequently, the devices are registered while a user does not recognize the devices. As a result, it is difficult for a user to understand the configuration of the network that the user manages.

In addition, even when the network management apparatus 1 detects the devices on the network 2 which are not necessary to be managed, the devices are automatically registered in the network configuration diagram. Consequently, the network management apparatus unnecessarily monitors the state of the devices which are not required to be managed.

Alternatively, even when the network management apparatus 1 detects the devices which are not allowed to be connected to the network 2, the devices are automatically registered in the network configuration diagram. Consequently, even when the unauthorized devices are connected, the user can not recognize the devices.

### SUMMARY OF THE INVENTION

The present invention has been made in view of the above circumstances, and provides a network management apparatus capable of automatically detecting devices on a network and preventing unauthorized devices from being connected to the network by making a user be able to select management target devices from the automatically detected devices.

In some implementations, a network management apparatus of the invention, comprising:

a communication section connected to a network;

a memory for storing a network configuration diagram;

a display;

an input section; and

an arithmetic control section,

wherein when at least one device being connected to the network is detected, the arithmetic control section displays an indication on the display whether the device is to be registered in the network configuration diagram, and

the arithmetic control section registers the device in the network configuration diagram based on an instruction inputted from the input section.

In this manner, since a user can determine whether the device is to be registered, the user can select the management target device among the detected devices. In addition, it is possible to prevent an unauthorized device from being connected.

In the network management apparatus,

when the device being connected to the network is detected, the arithmetic control section displays on the display a difference between the detected device and a device registered in the network configuration diagram, and the indication whether the device displayed as the difference is to be registered in the network configuration diagram, and

the arithmetic control section registers the device in the network configuration diagram based on the instruction inputted from the input section.

In this manner, since a user can determine whether the device is to be registered, the user can select the management target device among the detected devices. In addition, it is possible to prevent an unauthorized device from being connected.

In some implementations, a network management apparatus of the invention, comprising:

a communication section connected to a network;

a memory for storing a network configuration diagram; and

an arithmetic control section,

wherein when at least one device being connected to the network is detected, the arithmetic control section compares the detected device and a device registered in the network configuration diagram, and

when there is a difference as a result of the comparison, the arithmetic control section notifies of the difference.

In this manner, since a user can grasp the device being connected to the network, it is possible to prevent an unauthorized device from being connected.

In the network management apparatus, the arithmetic control section notifies of the difference by transmitting an e-mail. In this manner, since a user can grasp the device being connected to the network, it is possible to prevent an unauthorized device from being connected.

The network management apparatus, further comprising:

an alarm unit, and

wherein the arithmetic control section notifies of the difference by sounding the alarm unit.

In this manner, since a user can grasp the device being connected to the network, it is possible to prevent an unauthorized device from being connected.

The network management apparatus, further comprising:

an alarm unit, and

wherein the arithmetic control section notifies of the difference by lighting or blinking the alarm unit.

In this manner, since a user can grasp the device being connected to the network, it is possible to prevent an unauthorized device from being connected.

The network management apparatus., further comprising:

a display section, and

wherein the arithmetic control section notifies of the difference by displaying a message on the display section.

In this manner, since a user can grasp the device being connected to the network, it is possible to prevent an unauthorized device from being connected.

### BRIEF DESCRIPTION OF THE DRAWINGS

FIG. 1 is a configuration block diagram illustrating a network management apparatus according to an embodiment of the invention.

FIG. 2 is a block diagram illustrating the configuration of the network management apparatus.

FIG. 3 is a flowchart illustrating one operation of the network management apparatus.

FIG. 4 is a flowchart illustrating another operation of the network management apparatus.

FIG. 5 is a flowchart illustrating another operation of the network management apparatus.

FIG. 6 is a block diagram illustrating the network management apparatus according to another embodiment of the invention.

FIG. 7 is an exemplary block diagram illustrating a configuration of a network management apparatus of the related art.

FIG. 8 is a block diagram illustrating the configuration of the network management apparatus of the related art.

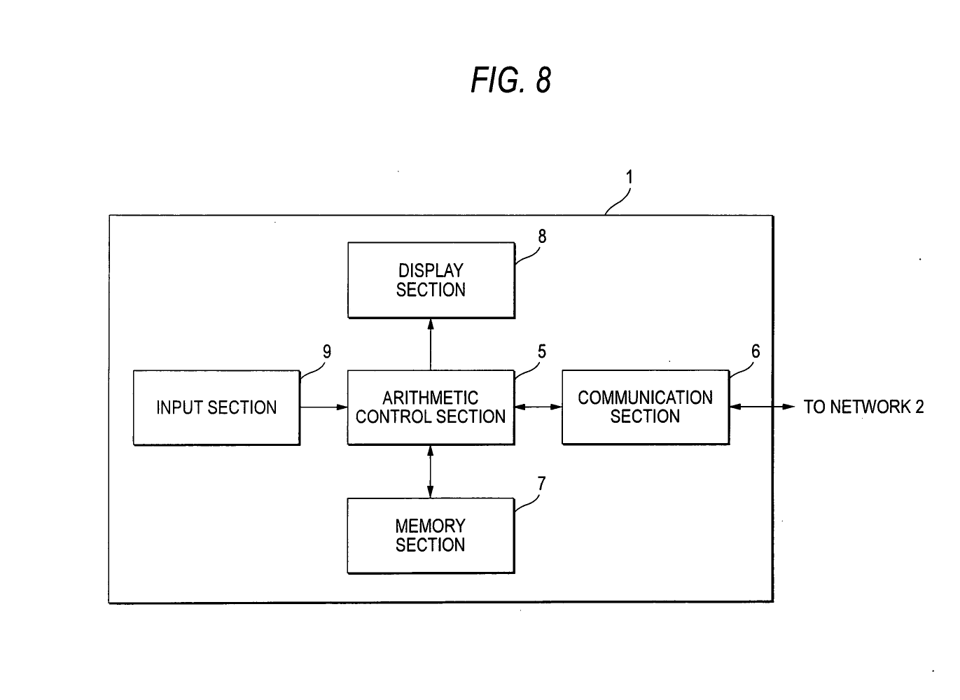

FIG. 9 is a flowchart illustrating an operation of the network management apparatus of the related art.

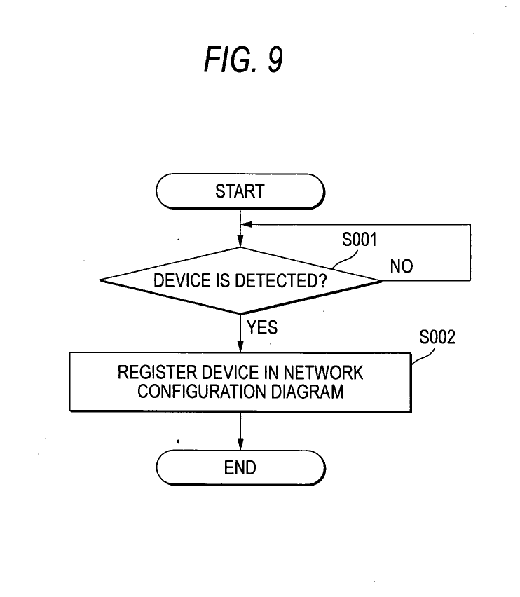

### DESCRIPTION OF THE PREFERRED EMBODIMENTS

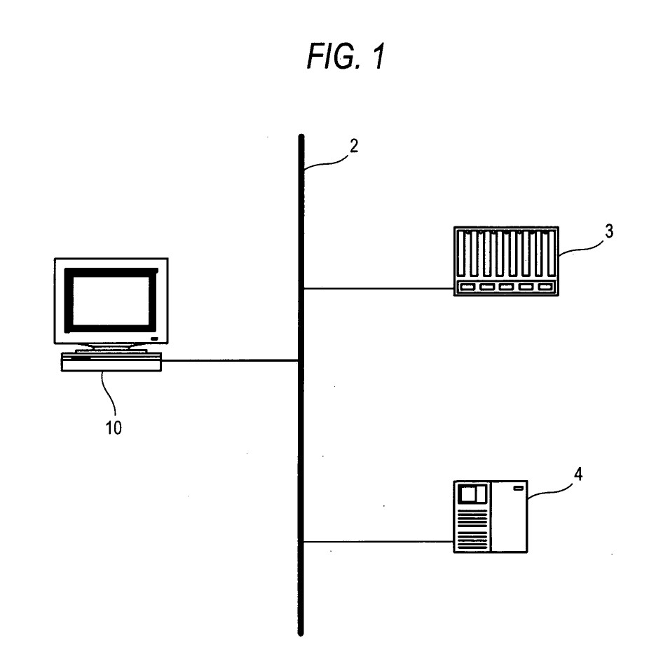

Hereinafter, embodiments of the invention will be described with reference to drawings. FIG. 1 is a configuration block diagram illustrating a network management apparatus according to an embodiment of the invention.

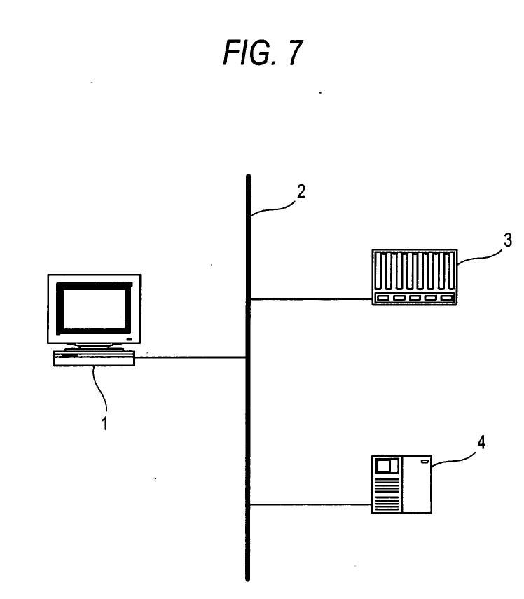

The reference numerals 2, 3, 4 shown in FIG. 1 are the same as those shown in FIG. 7, and reference numeral 10 is a network management apparatus for managing a network. The network management apparatus 10 and the devices 3 and 4 are connected to the network 2 respectively.

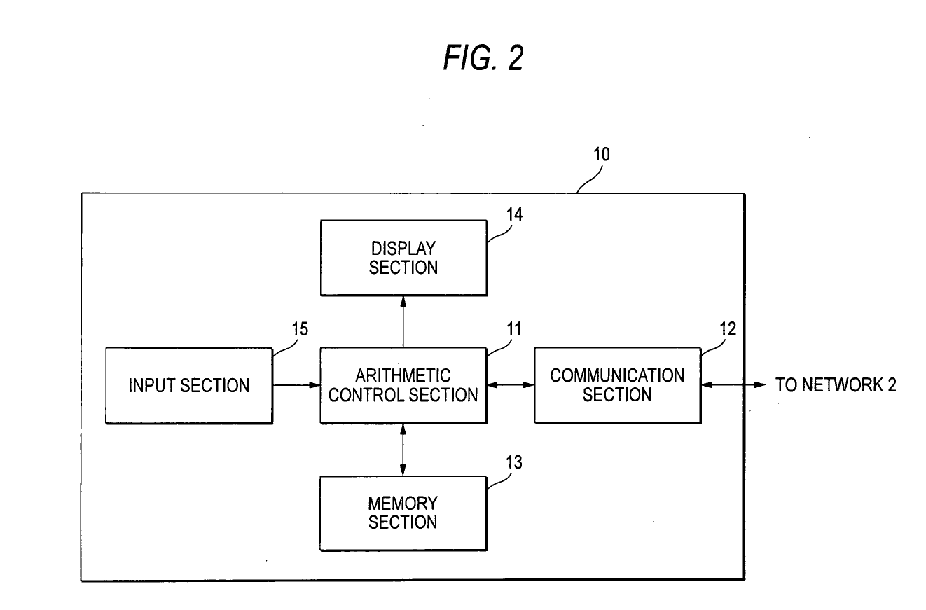

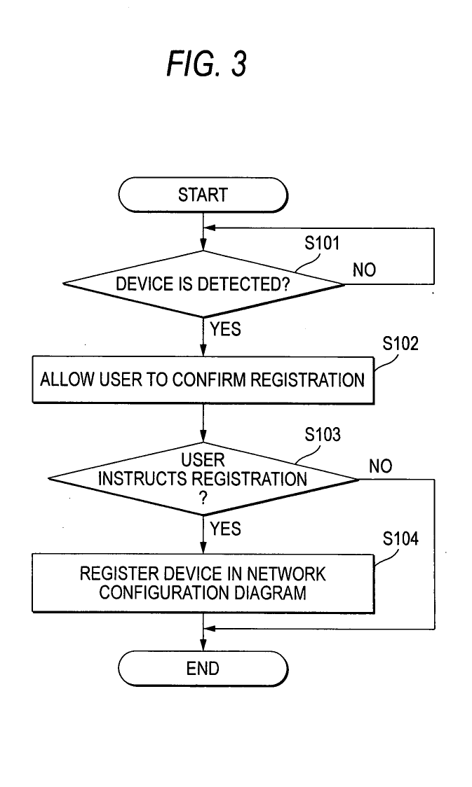

An operation of the embodiment shown in FIG. 1 will be described with reference to FIGS. 2 and 3. FIG. 2 is a block diagram illustrating a configuration of the network management apparatus 10, and FIG. 3 is a flowchart illustrating an operation of the network management apparatus 10. According to the embodiment, in the operation shown in FIG. 3, a user can confirm whether the device should be registered in the network configuration diagram.

In FIG. 2, reference numeral 11 denotes an arithmetic control section such as CPU, reference numeral 12 denotes a communication section for transmitting and receiving data to and from the devices 3 and 4 via the network 2. Reference numeral 13 denotes the memory section such as ROM, RAM, a flash memory or a hard disk, reference numeral 14 denotes the display section such as CRT, and reference numeral 15 denotes the input section such as a keyboard.

The network management apparatus 10 includes the arithmetic control section 11, the communication section 12, the memory section 13, the display section 14 and the input section 15. The arithmetic control section 11 is connected to the communication section 12, the memory section 13, the display section 14 and the input section 15 respectively.

The network management apparatus 10 has the automatic detection function, and application software of the automatic detection function is installed in the memory section 13 in advance. Data including the network configuration diagram is stored in the memory section 13 in advance so that the network management apparatus 10 can manage the devices connected to the network 2.

In step “S101” shown in FIG. 3, the arithmetic control section 11 of the network management apparatus 10 reads the application software having the automatic detection function from the memory section 13 to execute the application software, controls the communication section 12 and thus determines whether the devices are detected on the network 2. When the devices are detected, the process goes to step S102 in FIG. 3.

On the other hand, in step “S101” shown in FIG. 3, the arithmetic control section 11 of the network management apparatus 10 reads the application software having the automatic detection function from the memory section 13 to executes the application software, controls the communication section 12 and thus determines whether the devices are detected on the network 2. When the devices are not detected, the process waits in step S101 in FIG. 3.

In step “S102” shown in FIG. 3, the arithmetic control section 11 of the network management apparatus 10 displays an indication on the display section 14 so that a user can confirm and select whether to register the detected devices or not. The user inputs an instruction to register the detected devices or not to register the detected devices, by using the input section 15.

In step “S103” shown in FIG. 3, the arithmetic control section 11 of the network management apparatus 10 determines whether the user inputs the instruction of the registration of the detected devices or not. Then, the process goes to step “S104” in FIG. 3 when the registration is instructed.

On the other hand, in step “S103” shown in FIG. 3, the arithmetic control section 11 of the network management apparatus 10 determines whether the user instructs the registration of the detected devices. Then, the arithmetic control section 11 does not register the detected devices in the network configuration diagram when the user does not instruct the registration.

Finally, in step “S104” shown in FIG. 3, the arithmetic control section 11 of the network management apparatus 10 registers the detected device in the network configuration diagram. Afterward, the monitoring of the state of the registered devices is initiated.

As a result, the arithmetic control section 11 of the network management apparatus 10 detects the devices on the network 2, the user confirms whether the devices should be registered in the network configuration diagram. In addition, the arithmetic control section 11 registers the devices in the network configuration diagram based on the instruction of the registration by the user. In this manner, since the user can determine whether to register the detected devices or not, the user can select the management target devices from the automatically detected devices and prevent the unauthorized devices from being connected.

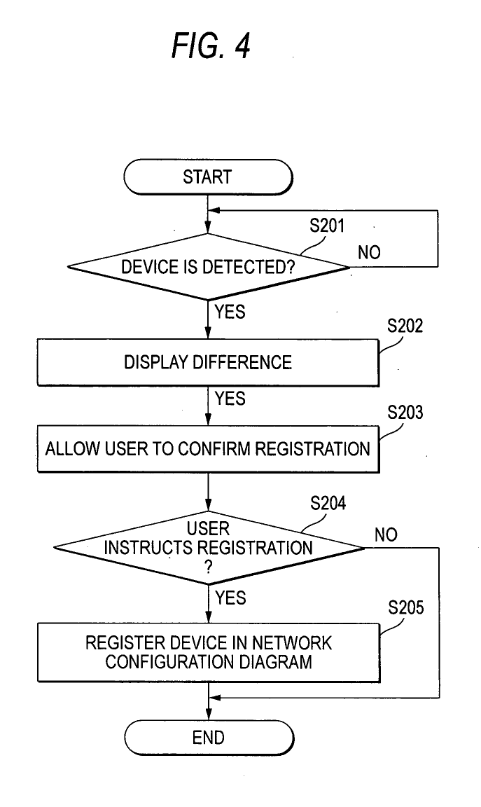

FIG. 4 is a flowchart illustrating another operation of the network management apparatus 10. In another operation of the embodiment shown in FIG. 4, a difference between the devices that have been registered in the network configuration diagram and the devices that are connected to the network 2 is displayed before the user confirms whether the devices should be registered in the network configuration diagram.

In step “S201” shown in FIG. 4, the arithmetic control section 11 of the network management apparatus 10 reads the application software having the automatic detection function from the memory section 13 to execute the application software, controls the communication section 12 and thus determines whether the devices are detected on the network 2. The process goes to step “S202” shown in FIG. 4 when the devices are detected.

On the other hand, in step “S201” shown in FIG. 4, the arithmetic control section 11 of the network management apparatus 10 reads the application software having the automatic detection function from the memory section 13 to execute the application software, controls the communication section 12 and thus determines whether the devices are detected on the network 2. When the devices are not detected, the process waits in step S201 in FIG. 4.

In step “S202” shown in FIG. 4, the arithmetic control section 11 of the network management apparatus 10 displays on the display section 14 a difference between the devices that have been registered in the network configuration diagram and the devices that are detected on the network 2.

In addition, in step “S203” shown in FIG. 4, the arithmetic control section 11 of the network management apparatus 10 displays an indication on the display section 14 so that a user can confirm and select whether or not to register the devices displayed as the difference. The user inputs an instruction to register the detected devices or not to register the devices, by using the input section 15.

In step “S204” shown in FIG. 4, the arithmetic control section 11 of the network management apparatus 10 determines whether a user instructs the registration. When the user instructs the registration, in step “S205” shown in FIG. 4, the arithmetic control section 11 of the network management apparatus 10 registers the devices having the difference, in the network configuration diagram. Afterward, the monitoring of the state of the registered devices is initiated.

On the other hand, in step “S204” shown in FIG. 4, the arithmetic control section 11 of the network management apparatus 10 determines whether a user instructs the registration of the device. When the user does not instruct the registration, the arithmetic control section 11 of the network management apparatus 10 does not register the device having the difference, in the network configuration diagram.

As a result, the arithmetic control section 11 of the network management apparatus 10 detects the device on the network 2, displays a difference between the device registered in the network configuration diagram and the device connected to the network 2, a user confirms whether the device having the difference should be registered in the network configuration diagram, and the arithmetic control section 11 registers the device in the network configuration diagram based on a user's instruction of the registration. In this manner, since a user can determine whether to register the device, the user can select the management target device from the automatically detected devices. In addition, it is possible to prevent an unauthorized device from being connected.

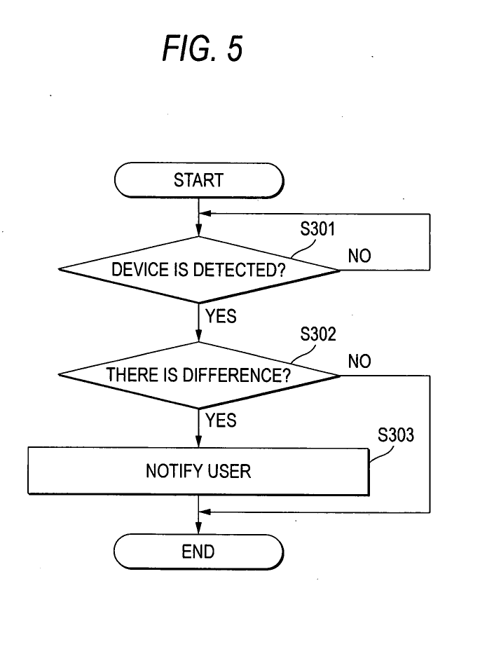

FIG. 5 is a flowchart illustrating another operation of the network management apparatus 10. In step “S301” shown in FIG. 5, the arithmetic control section 11 of the network management apparatus 10 reads the application software having the automatic detection function from the memory section 13 to execute the application software, controls the communication section 12 and thus determines whether the devices are detected on the network 2. When the devices are detected, the process goes to step “S302” shown in FIG. 5.

On the other hand, in step “S301” shown in FIG. 5, the arithmetic control section 11 of the network management apparatus 10 reads the application software having the automatic detection function from the memory section 13 to execute the application software, controls the communication section 12 and thus determines whether the devices are detected on the network 2. When the devices are not detected, the process waits in step “S301” shown in FIG. 5.

In step “S302” shown in FIG. 5, the arithmetic control section 11 of the network management apparatus 10 compares the device registered in the network configuration diagram with the device connected to the network 2, and then determines whether there is a difference therebetween. When there is a difference, the arithmetic control section 11 of the network management apparatus 10 notifies the user of the difference in step “S303” shown in FIG. 5.

The network management apparatus 10 notifies a user by using an e-mail, an alarm unit and the like. Specifically, when there is the difference, the network management apparatus 10 notifies the user of the difference by transmitting the e-mail, sounding the alarm unit, lighting or blinking the alarm unit, or displaying a message on the display section 14.

As a result, the arithmetic control section 11 of the network management apparatus 10 detects the device on the network 2 and compares the device registered in the network configuration diagram with the device connected to the network 2 to notify a user when there is the difference. In this manner, since a user can grasp the devices connected to the network 2, it is possible to prevent an unauthorized device from being connected.

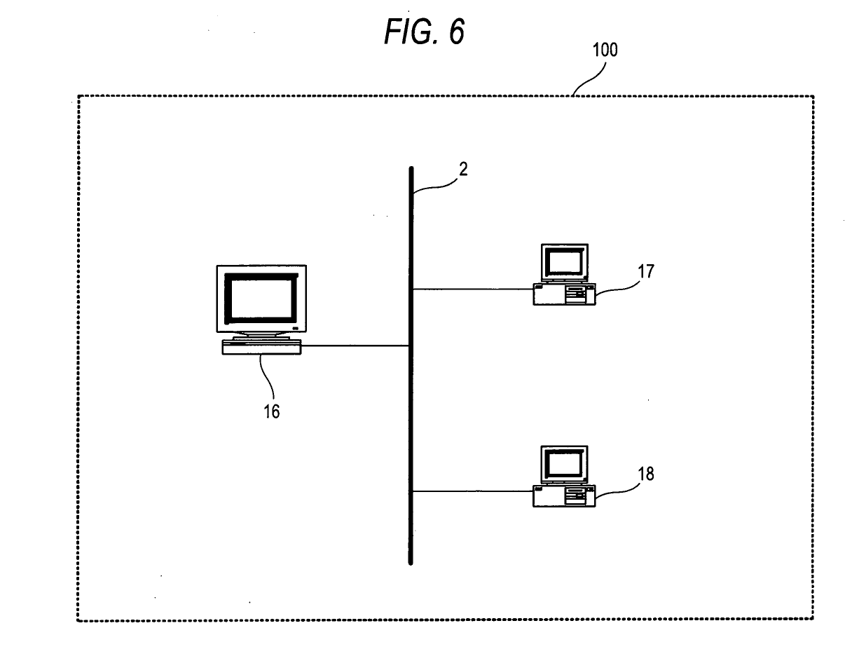

FIG. 6 is a block diagram illustrating a configuration of the network management apparatus according to another embodiment. In FIG. 6, reference numeral 2 is the same as that used in FIG. 7. Reference numeral 16 denotes a network management apparatus for managing the network, and reference numerals 17 and 18 denote terminals used for accessing the network management apparatus 16.

An electronic conferencing system 100 includes the network 2, the network management apparatus 16, and devices 17 and 18. The network management apparatus 16 and the terminals 17 and 18 are connected to the network 2 respectively.

Similarly as in FIG. 2, the network management apparatus 16 includes the arithmetic control section 11, the communication section 12, the memory section 13, the display section 14, and the input section 15. Attendant list data are stored in the memory section 13 in advance so that the network management apparatus 16 can manage the attendants who attend in a meeting.

Operation according to the embodiment shown in FIG. 6 will be described. The arithmetic control section 11 of the network management apparatus 16 receives a request to attend the meeting from the terminal 17 or 18, and displays the data of the attendance requests on the display section 14.

A user, who is a chairman of the conference for example, selects the attendants of the conference on the basis of the displayed data and instructs the network management apparatus 16 to register the selected attendants in the attendant list.

As a result, the arithmetic control section 11 of the network management apparatus 16 receives the attendance request from the attendant of the conference via the network 2, confirms the user, the chairman, whether to register in the attendant list the attendant who sent the attendance request, and registers the attendant in the attendant list based on the user's instruction of the registration. In this manner, since the user can determine whether the attendant who sent the attendance request can attend in the conference in response to the condition of the other attendance requests, it is possible to make the important person attend the meeting among the attendance requests.

In the embodiment shown in FIG. 1, only the two devices 3 and 4 are connected to the network 2. However, two devices are not necessarily connected, and one or more devices may be connected.

Likewise, only the two terminals 17 and 18 are connected to the network 2 in another embodiment shown in FIG. 6, but two devices are not necessarily connected. One or more devices may be connected.

The present invention has the advantages as follows. According to the invention, the arithmetic control section of the network management apparatus detects the device on the network, allows a user to determine whether the device is to be registered in the network configuration diagram, and registers the device in the network configuration diagram based on a user's instruction of the registration. In this manner, since a user can determine whether the device is to be registered, the user can select the management target devices from the automatically detected devices. In addition, it is possible to prevent an unauthorized device from being connected.

According to the invention, the arithmetic control section of the network management apparatus detects the device on the network, displays a difference between the device registered in the network configuration diagram and the device connected to the network, allows a user to determine whether the device displayed as the difference is to be registered in the network configuration diagram, and registers the device in the network configuration diagram based on a user's instruction of the registration. In this manner, since a user can determine whether the device is to be registered, the user can select the management target device from the automatically detected devices. In addition, it is possible to prevent an unauthorized device from being connected.

According to the invention, the arithmetic control section of the network management apparatus detects the device on the network, compares the device registered in the network configuration diagram with the device connected to the network, and when there is a difference therebetween, notifies the user of the difference. In this manner, since the user can grasp the device connected to the network, it is possible to prevent the unauthorized device from being connected.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A network management apparatus, comprising:
a communication section connected to a network;
a memory for storing a network configuration diagram;
a display;
an input section; and
an arithmetic control section,
wherein when at least one device being connected to the network is detected, the arithmetic control section displays an indication on the display whether the device is to be registered in the network configuration diagram, and
the arithmetic control section registers the device in the network configuration diagram based on an instruction inputted from the input section.

2. The network management apparatus as claimed in claim 1,
wherein when the device being connected to the network is detected, the arithmetic control section displays on the display a difference between the detected device and a device registered in the network configuration diagram, and the indication whether the device displayed as the difference is to be registered in the network configuration diagram, and
the arithmetic control section registers the device in the network configuration diagram based on the instruction inputted from the input section.

3. A network management apparatus, comprising:
a communication section connected to a network;
a memory for storing a network configuration diagram; and
an arithmetic control section,
wherein when at least one device being connected to the network is detected, the arithmetic control section compares the detected device and a device registered in the network configuration diagram, and
when there is a difference as a result of the comparison, the arithmetic control section notifies of the difference.

4. The network management apparatus as claimed in claim 3, wherein the arithmetic control section notifies of the difference by transmitting an e-mail.

5. The network management apparatus as claimed in claim 3, further comprising:
an alarm unit, and
wherein the arithmetic control section notifies of the difference by sounding the alarm unit.

6. The network management apparatus as claimed in claim 3, further comprising:
an alarm unit, and
wherein the arithmetic control section notifies of the difference by lighting or blinking the alarm unit.

7. The network management apparatus as claimed in claim 3, further comprising:
a display section, and
wherein the arithmetic control section notifies of the difference by displaying a message on the display section.
